(19) United States
(12) Patent Application Publication
(10) Pub. No.: US 2013/0117656 A1
(43) Pub. Date: May 9, 2013

(54) CONVERSION OF WEB TEMPLATE DESIGNS

(71) Applicants: Adri Verlaan, Seattle, WA (US); John Ronald Berkeley, Kenmore, WA (US); Ethan Gur-esh, Redmond, WA (US); Oguz Mut, Redmond, WA (US); Kaare Koehler Hoevik, Sammamish, WA (US); Alexander Lee Smith, Sammamish, WA (US)

(72) Inventors: Adri Verlaan, Seattle, WA (US); John Ronald Berkeley, Kenmore, WA (US); Ethan Gur-esh, Redmond, WA (US); Oguz Mut, Redmond, WA (US); Kaare Koehler Hoevik, Sammamish, WA (US); Alexander Lee Smith, Sammamish, WA (US)

(73) Assignee: MICROSOFT CORPORATION, Redmond, WA (US)

(21) Appl. No.: 13/291,119

(22) Filed: Nov. 8, 2011

(51) Int. Cl. G06F 17/00

(52) U.S. Cl. 715/234

(57) ABSTRACT

A portion of the CMS stage of web site development is automated to convert a static markup language mockup and its referenced resources into a renderable CMS web template. One or more features in the mockup are represented by one or more static markup language elements, which are replaced by one or more CMS instructions during the conversion process. The placement of the CMS instructions within the CMS web template is based on the type of feature and/or the type of the corresponding CMS instruction. Further, one or more additional CMS instructions are added to satisfy a rendering condition, so that the CMS web template is renderable and/or functional as part of a webpage with associated content provided through a CMS.

### CROSS-REFERENCE TO RELATED APPLICATIONS

The subject matter of the present application is related to subject matter of U.S. Nonprovisional patent application Ser. No. ______ [Attorney Docket No. 334095.01], entitled “Designing Interactive Web Templates” and filed concurrently herewith, which is incorporated by reference herein for all that it discloses and teaches.

### BACKGROUND

A content management system (CMS) provides a framework for website authoring, collaboration, and administration. A user with little or no programming or webpage design knowledge can enter his or her own content, such as press releases, images, articles, new personnel biographies, etc., into a website design provided by a knowledgeable website designer and/or programmer. In this paradigm, the user can purchase a professionally developed website and then populate it with his or her own new content without requiring the services of the website vendor to update the website with the new content. Instead, the website is equipped with a CMS through which the user can enter his or her content so that the content is rendered within the consistent design of the originally developed website.

For example, a business's website may be professionally designed using templates to provide a consistent theme, including without limitation, the color, size, placement and styles of titles, controls, text, etc. Typically, such themes are propagated throughout the website within some limited variation to maintain a sense of unity within the website. However, the content of such websites can change as the communication needs of the business change. An example is the addition of a press release on a new product—the business will typically want to post the press release on its website. The user can input the press release content into a website via a CMS, which combines the new content with master page templates and/or page layout templates to create a new consistently designed webpage containing the new content for the website.

In some environments, a CMS is based on a static markup language, such as HTML. The content and web templates are combined offline and stored as static HMTL until a user accesses the new webpage (e.g., using a URL referencing the new webpage), at which point a web server retrieves the static webpage and presents it to the requesting user (e.g., through the user's browser). In other environments, a CMS is based on dynamic rendering of each webpage upon request (e.g., the HTML defining the requested webpage is dynamically rendered in response to the user's request). The latter approach can provide more sophisticated and adaptive features within the website.

During a typical website development cycle, a graphic designer works with a client to develop the graphical elements for the website, often presenting the client with wire frame images depicting different examples of web pages and templates for comparisons. In a subsequent phase of the website development cycle, an HTML designer replaces various features in an example website or template image with static HTML elements to provide an HTML mockup of the proposed web page or template. For example, a wire frame image of a menu bar would be replaced with an HTML element for a menu bar. To implement the web page or template in a CMS, a web developer designer then manually replaces the generally non-functional HTML elements with CMS counterpart elements. However, simple one-for-one replacement is typically insufficient, resulting in a non-functional webpage or template. As such, automating the CMS stage proves challenging.

### SUMMARY

Implementations described and claimed herein address the foregoing problems by automating a portion of the CMS stage of web site development to convert a static markup language mockup and its referenced resources into a renderable CMS web template. One or more features in the mockup are represented by one or more static markup language elements, which are replaced by one or more CMS instructions during the conversion process. The placement of the CMS instructions within the CMS web template is based on the type of feature and/or the type of the corresponding CMS instruction. Further, one or more additional CMS instructions are added to satisfy a rendering condition, so that the CMS web template is renderable and/or functional as part of a webpage with associated content is provided through a CMS.

In some implementations, articles of manufacture are provided as computer program products. One implementation of a computer program product provides one or more tangible computer program storage media readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates example stages in a CMS web template design process.

FIG. 2 illustrates an example design converter for generating functional CMS web templates.

FIG. 3 illustrates an example design converter used in combination with a CMS.

FIG. 4 illustrates an example CMS web template shown in an authoring tool.

FIG. 5 illustrates example operations for converting a static markup language mockup into a functional CMS web template.

FIG. 6 illustrates an example system for providing a server preview of one or more CMS web templates.

FIG. 7 illustrates example operations for providing a server preview of one or more CMS web templates.

FIG. 8 illustrates an example system that may be useful in implementing the described technology.

### DETAILED DESCRIPTIONS

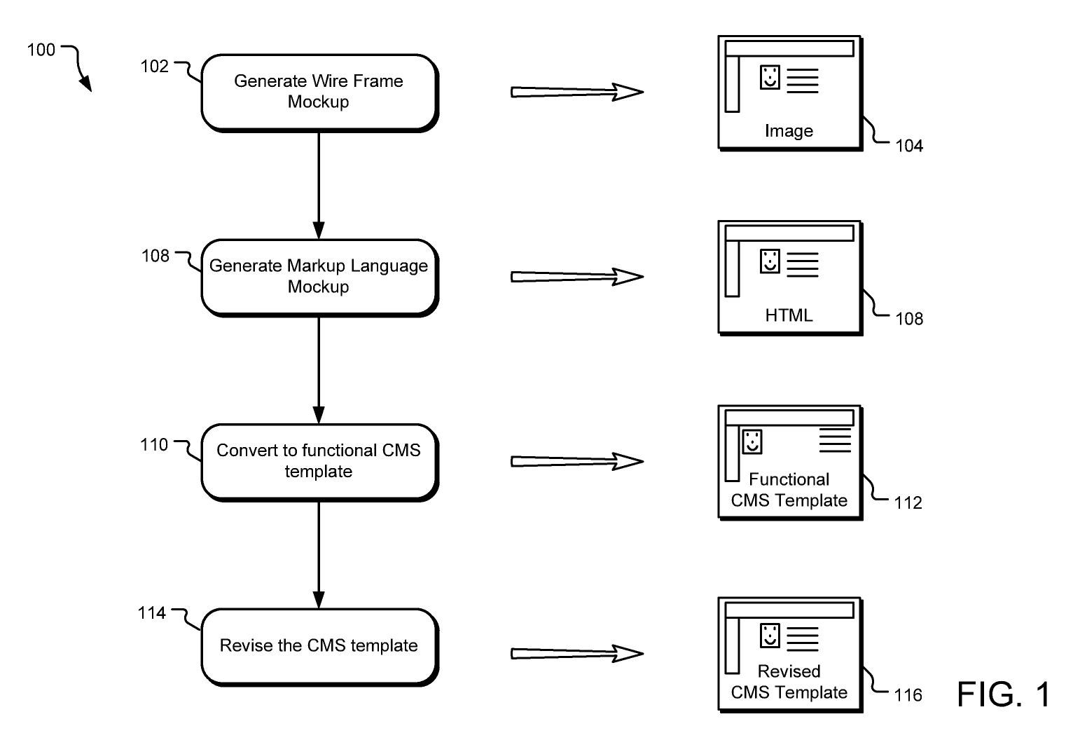

FIG. 1 illustrates example stages in a CMS web template design process 100. In a wire frame stage 102, a graphic designer generates one or more images 104 depicting possible web templates for a client's website. The images are typically generated using a graphics program, illustrating possible renderings of a web template for the client to consider. The graphic designer and the client can use the images to compare different possible graphical features of the web site, including without limitation different colors, placements, and sizes of elements, a flow between different webpages on the web site, the prominence of the client's branding, and the overall visual impact of the template and the proposed website.

In a mockup stage 106, a web developer takes the images selected for the web site and replaces graphical features of the images with individual static markup language elements, such as HTML elements. It should be understood that although HTML is described herein as an example static markup language, the term “markup language” is not limited to HTML and may include without limitation other languages, such as troff, LaTeX, and PostScript. One or more of the markup language elements may further reference other resources, such as image elements, video elements, audio elements, etc. The markup language elements (e.g., HTML elements) and their referenced resources are placed (e.g., inserted in a location within the web template) by the web developer in one or more datastores (e.g., files) so that the web template can be rendered, such as within a web browser as a mockup web template 108. The mockup web template 108 comprises rendered HTML elements, typically with little or dummy content (e.g., text, images, etc.). In this state, the mockup web template 108 can be used to judge the web template design but it generally does not provide significant functionality, if it provides any functionality at all. In particular, the mockup web template 108 does not provide CMS functionality.

In a conversion operation 110, the one or more datastores are uploaded to a design converter, which replaces one or more static markup language elements (e.g., HTML elements) with one or more CMS instructions as part of a CMS web template 112 based on the mockup web template 112. For example, a text box containing dummy text in the mockup is replaced with a CMS instruction of a text box that can be populated by content (e.g., a press release) provided via the CMS. In addition, certain additional CMS instructions may be required by the CMS to render the web template correctly with the appropriate content or to function correctly. In other implementations, certain CMS instructions may be suggested, but not required, to render the web template or provide web template functionality. The set of required and/or suggested CMS instructions defines a rendering condition. For example, in one implementation, a ribbon CMS instruction in MICROSOFT's SHAREPOINT CMS technology is required to yield a renderable and functional CMS web template. As such, the conversion operation 110 adds the CMS instruction for a CMS ribbon element into the functional CMS web template 112. Alternatively, the use of a footer in a master page template may be suggested. Accordingly, the conversion operation 110 may add a footer element to the CMS web template 112, although the author can delete or edit it at a later point.

In one implementation, the type of template that is generated from the conversion operation 110 (e.g., a master page template, a page layout template, etc.) can be specified in the mockup web template 108, such as in a tag specifying the template type in the markup language. An example master page template may define branding elements shared across all pages of a web site, while an example page layout template may define content placement within a specific web page of the web site. As alternatives to a tag inserted in the markup language of the mockup web template 108, other template type identifiers may be employed, including a value in a configuration file, a query result through a user interface, etc.

In one implementation, the conversion operation 110 updates the references in the replacing CMS instructions to reference the resources referenced by the replaced markup language elements. For example, if the mockup web template 108 includes an HTML background image element referencing an image resource, then the conversion operation 110 adds the reference to the image resource to the CMS instruction that it substitutes for the HTML background image element. Links between other HTML elements and referenced resources are propagated to their counterpart CMS instructions in a similar manner.

In another implementation, the conversion operation 110 places the CMS instructions within the template according to a placement scheme based on the type of the static markup language element and/or the type of the CMS web template. For example, if the CMS instruction replaces a footer element, the CMS instruction is inserted in a location near the bottom of the functional CMS web template 112 whereas a CMS instruction replacing a header element would be inserted in a location near the top of the functional CMS web template 112. In contrast, navigational CMS instructions would be inserted in a location near the top of the body of the functional CMS web template 112. Other CMS instructions can be placed according to a similar placement scheme. In one implementation, types of elements and/or instructions are mapped to different placement constraints or guidance by a mapping structure, such as a configuration datastore of the design converter or a placement datastore that associated with the mockup.

In the case of the additional CMS instructions added to make the functional CMS web template 112 renderable, placement of the additional CMS instructions is based on the type of the CMS instruction that is added. For example, the ribbon CMS instruction is added for placement near the top of the functional CMS web template 112. Placement of other CMS instructions can be place according to a similar placement scheme. In one implementation, types of elements and/or instructions are mapped to different placement constraints or guidance by a mapping structure, such as a configuration datastore of the design converter or a placement datastore that associated with the mockup.

In a revising operation 114, the web developer can adjust the placement of the CMS instructions provided in the conversion operation 110 to yield a revised CMS web template 116 having CMS elements placed according to the clients' wishes. Placement revisions may be accomplished through a graphical web authoring interface or through repositioning and/or editing of CMS instructions in a web template definition file, although other methods may be employed.

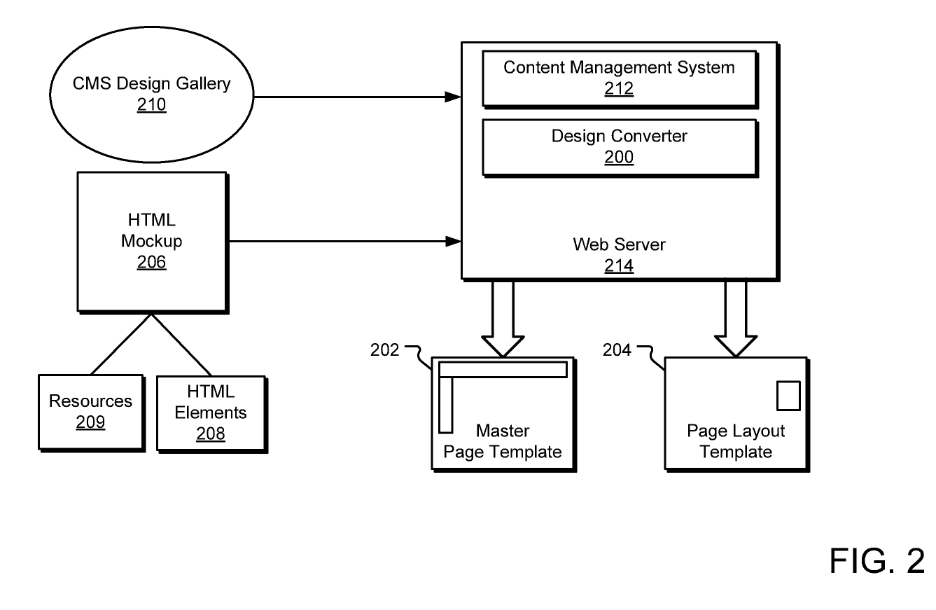

FIG. 2 illustrates an example design converter 200 for generating functional CMS web templates, such as a master page template 202 and a page layout template 204 (examples of web templates). A web developer creates an HTML mockup 206, which includes one or more HTML elements 208, such as a text boxes, navigation controls, menu bars, etc., and can reference one or more resources 209, such as images, audio, video, text, etc. The HTML mockup 206 defines the type of CMS web template desired from a design conversion process (e.g., master page template, page layout template).

A CMS design gallery 210 includes CMS elements (e.g., specified at least in part by CMS instructions) that are defined to work within the context of a CMS 212 executing on or in conjunction with a web server 214. The CMS design gallery 210 includes conversion information, which can include mapping information between HTML element types and CMS element types and/or instructions. The design converter 200 uses the mapping information to determine which CMS instructions replace which HTML elements. In addition, the conversion information can include parameters about the types of CMS web templates supported by the CMS design gallery 210 (e.g., master page template, page layout template, etc.), which HTML tags or other indicators specify which type of CMS web template, and which CMS instructions satisfy the rendering condition for the CMS web template. Further still, the conversion information can include placement qualifiers, which specify how CMS elements are to be placed relative to each other or relative to specified regions of the CMS web template (e.g., relative to a BODY tag).

In operation of an example implementation, the HTML mockup 206 and its referenced resources 209 and HTML elements 208 are uploaded to the design converter 200, which uses HTML mockup 206 and the CMS instructions and the conversion information in the CMS design gallery 210 to determine type of CMS web template to generate, to identify the CMS instructions used to replace the HTML elements, to link up the resource 209 to the replacing CMS instructions, to add additional CMS instructions to satisfy the rendering condition (e.g., to make the CMS web template renderable, to suggest improved functionality, etc.), and to place the CMS instructions in accordance with the type-based placement scheme. Using such inputs, the design converter 200 generates a renderable master page template 202, a renderable page layout template 204, or another renderable CMS web template for use with the CMS 212.

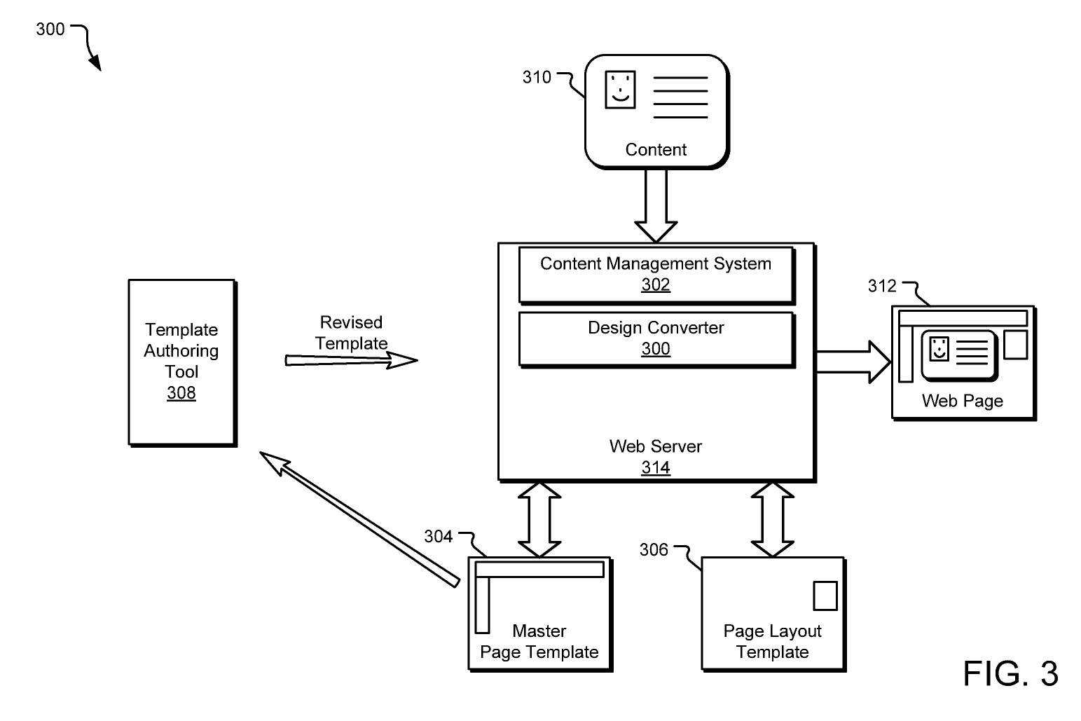

FIG. 3 illustrates an example design converter 300 used in combination with a CMS 302 executing on a web server 314. The design converter 300 was used to generate one or both of the master page template 304 and/or the page layout template 306. The web developer imports one of the templates into a template authoring tool 308, which in one implementation shows previews of the web template elements along with the corresponding CMS instructions, which are disabled (e.g., commented out). Within this tool, the web developer can manually revise the template (e.g., by moving CMS instructions within the code editing portion of the tool 308 or graphically moving the rendered preview of the elements within a graphical editing portion of the tool 308) to achieve a satisfactory design.

The revised template is uploaded to the design converter 300 for storage as a revised template. The CMS 302 can use the templates in combination with content 310 (e.g., provided by the client and combined in real time prior to rendering) to render a content-populated instance of a web page 312. It should be understood that, although the unrevised templates 304 and 306 may be rendered in the context of the CMS 302 without revision, a web developer is likely to make some revisions prior to publication of the template for use in a live web site.

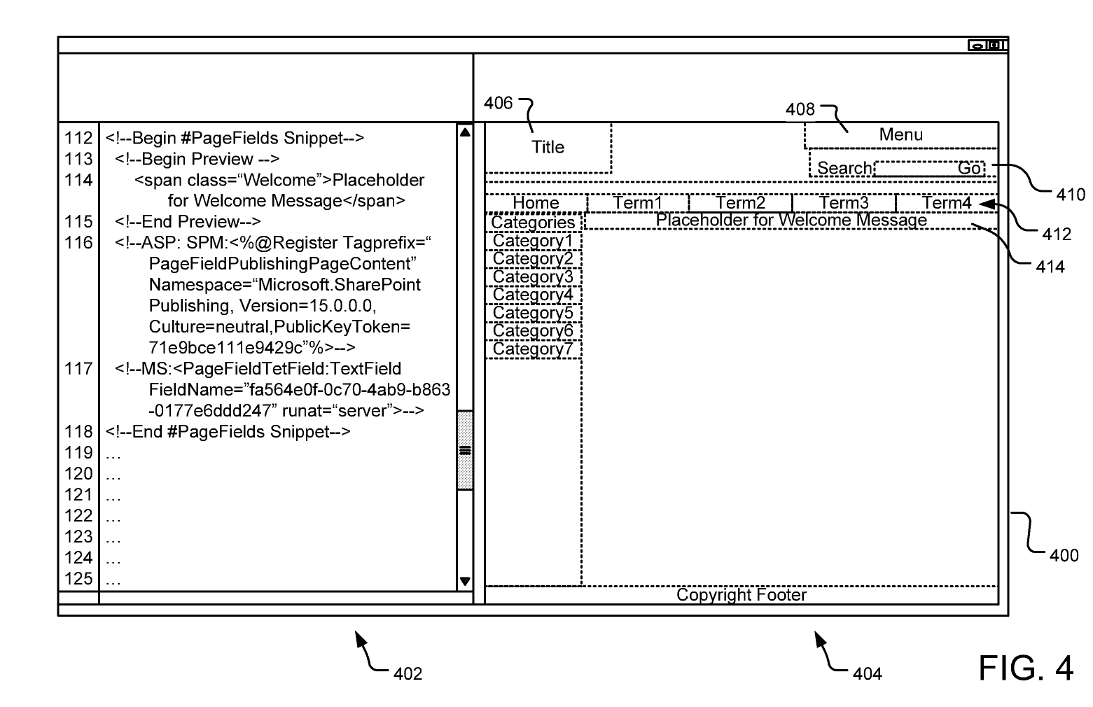

FIG. 4 illustrates an example CMS web template 400 shown in an authoring tool. A code editing section 402 is shown on the left, and a graphical editing section 404 is shown on the right. The web template preview shown in the graphical editing section 404 includes several HTML elements, including a title text box 406, a navigation menu element 408, a search control 410, a menu bar element 412, a text box 414, and other elements. The elements represent previews of the CMS elements in the CMS web template, represented as HTML elements in an HTML authoring tool.

The underlying HTML instructions that correspond to the preview of the Placeholder for Welcome Message test box 414 are shown in the code editing section 402. In addition to the enabled HTML instructions for the preview in line 114, the HTML instructions include a disabled CMS instruction for element in line 117. Note: A disabled ASP.Net directive of a DLL is also shown in line 116. In this manner of disabling and enabling insructions, the HTML “snippet” in the coding section includes information for both displaying the preview in the HTML authoring tool and for rendering the CMS element through the CMS executing on the web server. Another example snippet is shown below and includes an HTML instruction at line 3 representing the static markup language preview and an ASP.net instruction at line 5 representing a CMS instruction of the CMS element. The ASP.net instruction is enclosed in a comment structure and is therefore disabled, while the HTML instruction is enabled for processing and presentation by a static markup language-based template authoring tool.

| | |
|---|---|
| 1 | <!--Begin #PageFields Snippet--> |
| 2 | <!--Begin Preview --> |
| 3 | <span>Title</span> |
| 4 | <!--End Preview--> |
| 5 | <!--ASP: SPM:<%@Register |
| | Tagprefix=“PageFieldPublishingPageContent” |
| | Namespace=“Microsoft.SharePointPublishing, |
| | Version=15.0.0.0, Culture=neutral, |
| | PublicKeyToken=71e9bce111e9429c”%>--> |
| 6 | <!--End #PageFields Snippet--> |

The snippet includes one or more enabled static markup language instructions for a static markup language preview of the CMS element and one or more disabled CMS instructions for the CMS element. In one implementation, the one or more CMS instructions are disabled using a commenting feature of the static markup language, although other disabling options may be employed (e.g., a disabling property, tag, or flag that indicates to a template authoring tool that the one or more CMS instructions are disabled). When disabled, the one or more CMS instructions are operatively hidden from the static markup language-based template authoring tool or otherwise suppressed within the static markup language-based template authoring tool in some way. As such, the static markup language-based template authoring tool processes the static markup language instruction for the CMS element preview, presenting it to the user in a preview mode of the template static markup language-based template authoring tool. In one implementation, the HMTL instruction is disabled and the CMS instruction is enabled when the web template is uploaded and converted for use with the CMS.

The placement of the CMS elements (and their corresponding HTML preview elements) by the design converter is based on the type of the CMS element. One or more CMS templates are mapped to a placement constraint or guide to inform the design converter about a reasonable placement for the corresponding CMS instruction. Furthermore, placement schemes may differ depending on the type of web template. For example, a text box type element may be mapped for placement to the top of the BODY tag in a master page template while it might be mapped to the bottom of the BODY tag in a particular type of page layout.

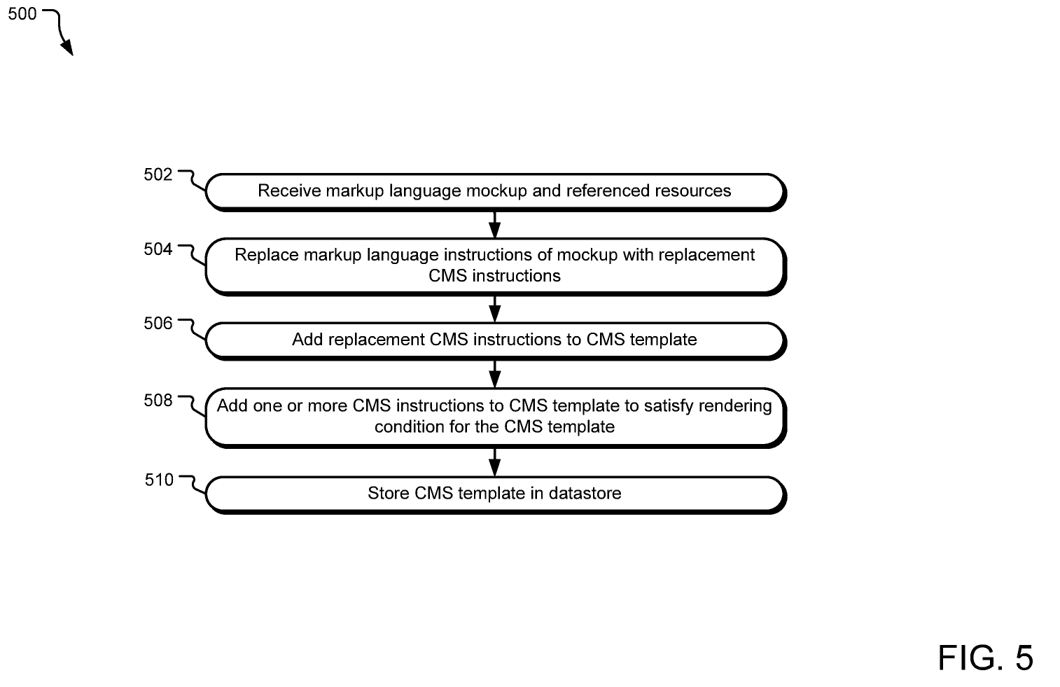

FIG. 5 illustrates example operations 500 for converting a static markup language mockup into a functional CMS web template. A receiving operation 502 receives a markup language mockup and its referenced resources to a design converter. A replacing operation 504 replaces the markup language instructions of the mockup with replacement CMS instructions. It should be understood that the replacement CMS instructions may be in a “snippet” format, with an enabled HTML preview element and a corresponding, disabled CMS instruction for use in an HTML authoring tool. A storing operation 506 adds the replacement CMS instructions to a CMS web template.

Another storing operation 508 adds one or more CMS instructions to the CMS web template to satisfy a rendering condition for the CMS template. The rending condition may include CMS instructions required for proper rendering or intended functionality. In addition or alternatively, the rending condition may include CMS instructions suggested for a particular functionality. Further, rendering conditions can vary among different types of web templates. As such, the CMS instructions added in the storing operation 508 can vary among different types of web templates. Yet another storing instructions 510 stores the CMS web template in one or more tangible computer-readable storage media.

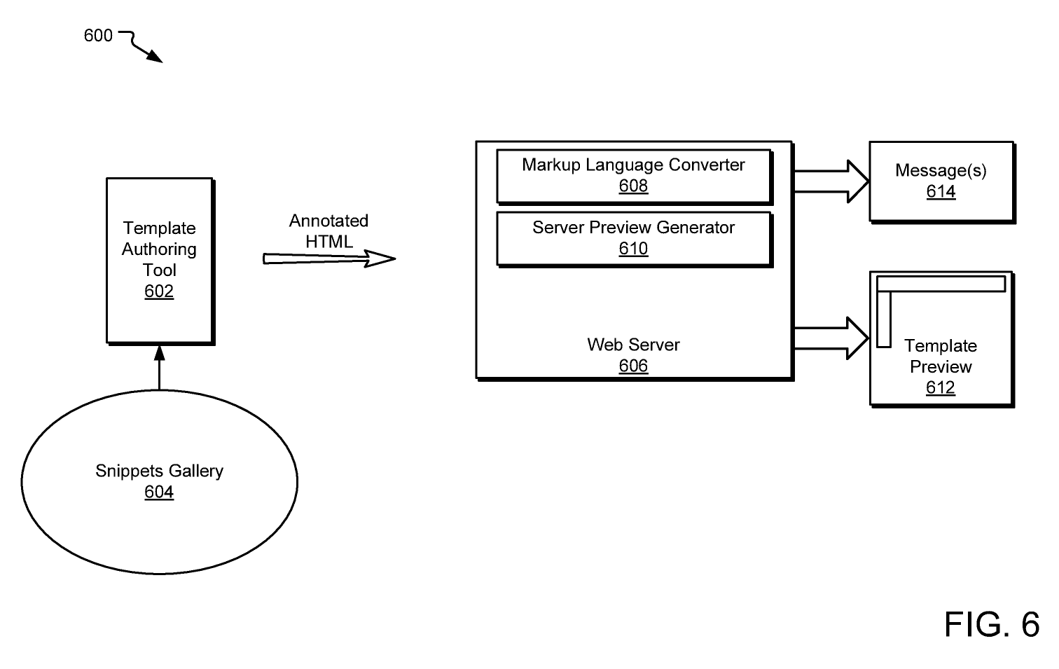

FIG. 6 illustrates an example system 600 for providing a server preview of one or more CMS web templates. While a CMS web template author creates a CMS web template within a template authoring tool 602 using a snippets gallery 604, the author may wish to preview the CMS web template to observe the way the CMS web template will be rendered by a web server 606 during normal operation. Accordingly, the web template author can upload the annotated HTML (e.g., the static markup language including one or more snippets) to the web server 606, where a markup language converter 608 disables the static markup language preview instructions and the enables CMS instructions for each CMS element. The resulting CMS web template is passed to a server preview generator 610, which renders a preview 612 of the CMS web template and/or generates one or more messages 614 associated with the rendering of the web template preview 612. In an alternative implementation, sample content data or even some form of live content data may be included in the rendering of the web template preview 412. Example messages may include without limitations error messages identifying errors in the CMS web template's instructions, guidance to other CMS elements the web template author may want to include in the CMS web template, etc.

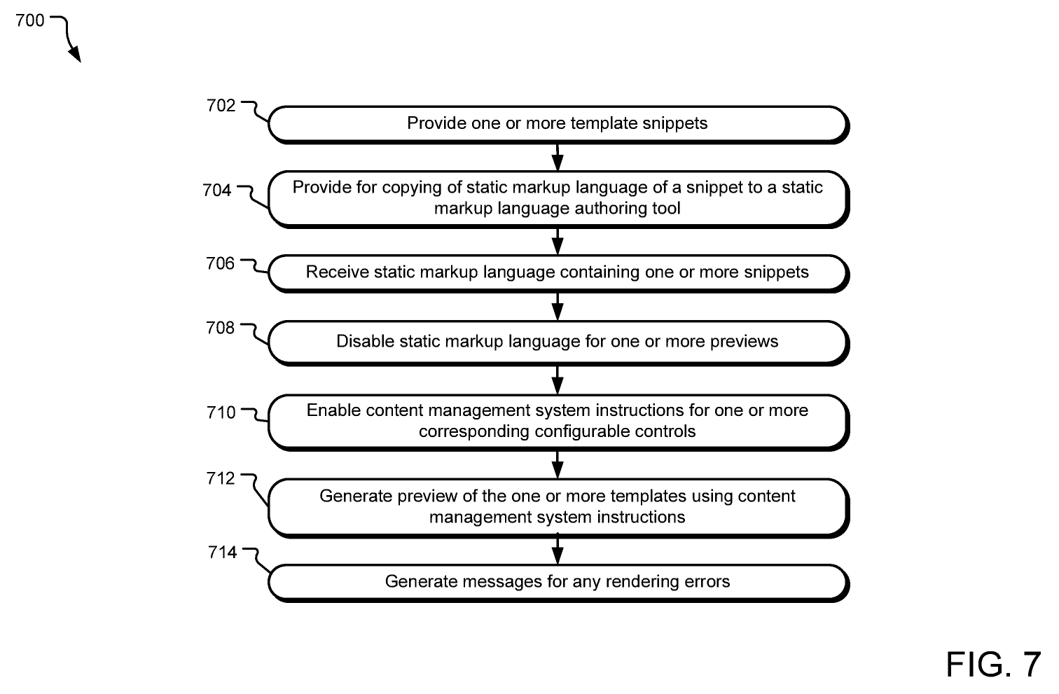

FIG. 7 illustrates example operations 700 for providing a server preview of one or more CMS web templates. A providing operation 702 provides one or more CMS element snippets, such as in a snippets gallery, for use by a web template author. Each snippet includes a static markup language preview of the CMS element and a CMS instruction for the CMS element. In one implementation, the static markup language preview is enabled and the CMS instruction is disabled within the snippets gallery, although, in other implementations, the enabling and disabling can be performed programmatically, such as during a copy and/or paste stage.

Another providing operation 704 provides a facility for copying the static markup language of a snippet associated with the CMS element. Once copied, the snippet can be copied into the coding section of a static markup language-based authoring tool for inclusion in a CMS web template.

At some point, the web template author can view a preview of the web template as it would appear in a browser, including one or more CMS elements that are represented by snippets. To view a preview in a browser, the web template author uploads the static markup language web template to a web server, which receives the web template in a receiving operation 706. A disabling operation 708 disables static markup language preview instructions, such as by deleting the preview instructions, commenting out the preview instructions, etc. An enabling operation 710 enables CMS instructions for the CMS elements that correspond to the disabled preview instructions (such as by removing a comment structure associated with the CMS instructions, modifying a property or tag associated with CMS instructions, etc.), leaving a web template that is compatible with the CMS used at a web server. A generating operation 712 renders a preview of the web template based on the enabled CMS instructions in the web template. Furthermore, one or more messages may be generated in a generating operation 714 to present the web template author with errors, warnings, guidance, etc. pertaining to the rendering of the preview by the web server.

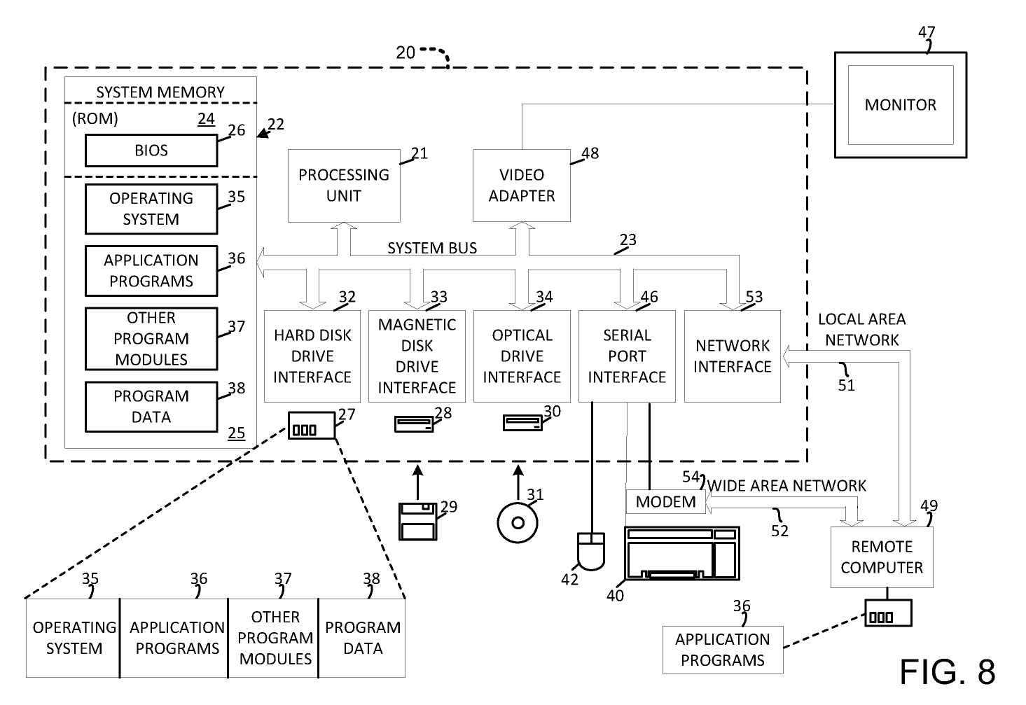

FIG. 8 illustrates an example system that may be useful in implementing the described technology. The example hardware and operating environment of FIG. 8 for implementing the described technology includes a computing device, such as general purpose computing device in the form of a gaming console or computer 20, a mobile telephone, a personal data assistant (PDA), a set top box, or other type of computing device. In the implementation of FIG. 8, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 8. The logical connections depicted in FIG. 8 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a content management system, a markup language converter, a snippets gallery engine, a server preview generator, and other modules and software systems may be embodied by instructions stored in memory 22 and/or storage devices 29 or 31 and processed by the processing unit 21. The snippets gallery, a master template, a page layout template, a webpage, messages, and other data may be stored in memory 22 and/or storage devices 29 or 31 as persistent datastores. Further, such modules and software systems may represent hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
replacing a markup language instruction of a markup language mockup with a content management system instruction stored to a content management system web template, the markup language mockup including one or more markup language instructions identifying one or more markup language elements;
adding one or more content management system instructions to the content management system web template in satisfaction of a rendering condition;
storing the content management system web template in a computer-readable tangible storage medium for access by a content management system.

2. The method of claim 1 wherein rendering conditions differ among different types of content management system web templates and the adding operation comprises:
determining a type of the content management system web template into which the markup language mockup is to be converted;
determining a set of one or more content management system instructions for satisfying the rendering condition for the determined type of the content management system web template;
determining one or more content management system instructions from the set of one or more content management system instructions missing from the content management system web template;
adding the one or more missing content management system instructions to the content management system web template.

3. The method of claim 1 wherein the adding operation operation comprises:
determining a type of the content management system web template into which the markup language mockup is to be converted from a tag attributed to the markup language mockup.

4. The method of claim 1 wherein the adding operation comprises:
determining a type of the content management system web template into which the markup language mockup is to be converted, the type indicating one of a master page template or a page layout template.

5. The method of claim 1 wherein the adding operation comprises:
determining a type of a content management system instruction to be added to the content management system web template;
inserting the content management system instruction in a location within the content management system web template based on the type of the content management system instruction.

6. The method of claim 1 wherein the adding operation comprises:
disabling one or more markup language instructions within the markup language mockup; and
enabling one or more content management system instructions defining the content management system element.

7. The method of claim 1 further comprising:
rendering the content management system web template as a web page.

8. The method of claim 1 further comprising:
presenting one or more messages pertaining to the rendering of the web template as a preview.

9. One or more computer-readable storage media encoding computer-executable instructions for executing on a computer system a computer process, the computer process comprising:
replacing a markup language instruction of a markup language mockup with a content management system instruction stored to a content management system web template, the markup language mockup including one or more markup language instructions identifying one or more markup language elements;
adding one or more content management system instructions to the content management system web template in satisfaction of a rendering condition; and
storing the content management system web template in a computer-readable tangible storage medium for access by a content management system.

10. The one or more computer-readable storage media of claim 9 wherein rendering conditions differ among different types of content management system web templates and the adding operation comprises:
determining a type of the content management system web template into which the markup language mockup is to be converted;
determining a set of one or more content management system instructions for satisfying the rendering condition for the determined type of the content management system web template;
determining one or more content management system instructions from the set of one or more content management system instructions missing from the content management system web template;
adding the one or more missing content management system instructions to the content management system web template.

11. The one or more computer-readable storage media of claim 9 wherein the adding operation comprises:
determining a type of the content management system web template into which the markup language mockup is to be converted from a tag attributed to the markup language mockup.

12. The one or more computer-readable storage media of claim 9 wherein the adding operation comprises:
determining a type of the content management system web template into which the markup language mockup is to be converted, the type indicating one of a master page template or a page layout template.

13. The one or more computer-readable storage media of claim 9 wherein rendering conditions differ among different types of content management system web templates and the adding operation comprises:
determining a type of a content management system instruction to be added to the content management system web template;
inserting the content management system instruction in a location within the content management system web template based on the type of the content management system instruction.

14. The one or more computer-readable storage media of claim 9 wherein the adding operation comprises:
disabling one or more markup language instructions within the markup language mockup; and
enabling one or more content management system instructions defining the content management system element.

15. The one or more computer-readable storage media of claim 9, wherein the computer process further comprises:
rendering the content management system web template as a web page.

16. The one or more computer-readable storage media of claim 9, wherein the computer process further comprises:
presenting one or more messages pertaining to the rendering of the web template as a preview.

17. A system comprising:
a design converter configured to replace a markup language instruction of a markup language mockup with a content management system instruction stored to a content management system web template, the markup language mockup including one or more markup language instructions identifying one or more markup language elements, the data converter being further configured to add one or more content management system instructions to the content management system web template in satisfaction of a rendering condition.

18. The system of claim 17 wherein the design converter is further configured to determine a type of the content management system web template into which the markup language mockup is to be converted, determine a set of one or more content management system instructions for satisfying the rendering condition for the determined type of the content management system web template, determine one or more content management system instructions from the set of one or more content management system instructions missing from the content management system web template, and add the one or more missing content management system instructions to the content management system web template.

19. The system of claim 17 wherein the design converter is further configured to determine a type of a content management system instruction to be added to the content management system web template and insert the content management system instruction in a location within the content management system web template based on the type of the content management system instruction.

20. The system of claim 17 wherein the design converter is further configured to disable one or more markup language instructions within the markup language mockup and enable one or more content management system instructions defining the content management system element.
